(19) United States
(12) Patent Application Publication
(10) Pub. No.: US 2008/0158210 A1
(43) Pub. Date: Jul. 3, 2008

(54) APPARATUS AND METHOD TO DISPLAY ICONS AND GRAPHIC TEXT

(75) Inventors: JOHN P. BOOS, Grayslake, IL (US); Xiaoping Bai, Lake Zurich, IL (US); Li Zhuang, Long Grove, IL (US); Zhiming(Jim) Zhuang, Kildeer, IL (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., Libertyville, IL (US)

(21) Appl. No.: 11/617,324

(22) Filed: Dec. 28, 2006

(51) Int. Cl. G09G 5/00; G09G 3/20

(52) U.S. Cl. 345/206; 345/55; 345/699

(57) ABSTRACT

A display comprising a display driver termination portion (106), a dot matrix region (402) and an icon region (403). The icon region located in-between the display driver termination area and the dot matrix area, wherein the dot matrix area has a resolution that is greater than the icon area.

### FIELD OF THE DISCLOSURE

The present disclosure relates generally to displays and more particularly to a display that has icons and text.

### BACKGROUND OF THE DISCLOSURE

Displays, such as those used as a user interface for electronic devices are generally square or rectangular in shape. In communications devices, the display is often configured to present both text and icons to efficiently provide information to the user. The display circuit layout generally requires that the graphic text area to be separate from the icon area of the display as a result of the electrical conductor layout. There are two basic types of conductor layouts for passive Flat Panel Displays (FPD), one is a dot matrix layout and the other is a segmented layout. The segmented layout is preferable for displaying icons in low resolution, which is generally incapable of displaying graphics text. The dot matrix layout theoretically works for any icons but it requires very high resolution to create good icon images. Neither the traditional segmented layout nor the traditional dot matrix layout in low resolution work for user interface designs that require high density complex icons displayed together with graphic text. Additionally, high density complex icons can not be displayed between the graphic text region and the conductor termination points that connect to the display driver with the traditional dot matrix or icon layouts.

The various aspects, features and advantages of the present disclosure will become more fully apparent to those having ordinary skill in the art upon careful consideration of the following Detailed Description thereof with the accompanying drawings described below. The drawings may have been simplified for clarity and are not necessarily drawn to scale.

### BRIEF DESCRIPTION OF THE DRAWINGS

The present invention is illustrated by way of example and not limitation in the accompanying figures, in which like references indicate similar elements.

FIG. 1 is an illustration of a display having specific icons and graphic text.

FIG. 2 is an illustration of a first substrate that has horizontal row conductive traces and dedicated icons.

FIG. 3 is an illustration of second substrate that has column conductive traces.

FIG. 4 is an illustration of a first substrate and a second substrate forming a display.

FIG. 5 is an illustration of a display having specific icons and graphic text.

FIG. 6 is an illustration of a lookup table for the display shown in FIG. 5.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

In general, a display 100 that comprises a conductor layout for simultaneously displaying detailed dedicated icons and low resolution graphic text is disclosed. The display is a flat panel display as commonly referred to by those having ordinary skill in the art. The display comprises a first substrate that has mixed row conductive traces and a specific dedicated icons layout and a second substrate that has a column conductive trace layout. The row conductive traces on the first substrate intersect the column conductive traces on the second substrate to form the dot matrix region of the display. The specific dedicated icons on the first substrate overlap the column conductive traces on the second substrate to form the icon region. With this configuration, detailed icons may be positioned between the graphic text region and a termination portion of the display. The display can therefore simultaneously activate detailed icons and graphic text without layout constraints.

Before describing in detail embodiments that are in accordance with the present invention, it should be observed that the present invention resides primarily in combinations of method steps and apparatus components related to the communication device, communication node, and method for silent redial. Accordingly, the apparatus components and method steps have been represented where appropriate by conventional symbols in the drawings, showing only those specific details that are pertinent to understanding the present invention, so as not to obscure the disclosure with details that will be readily apparent to those of ordinary skill in the art, having the benefit of the description herein.

In this document, relational terms such as first and second, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

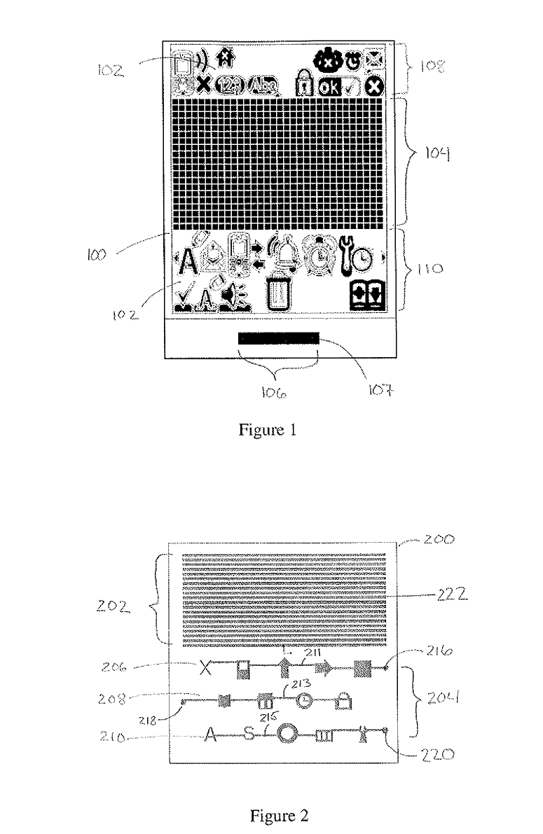

FIG. 1 is an illustrative display 100 comprising a dedicated icon region 102 and a graphic text region 104, wherein the icon region 102 is below the graphic text region 104 and between the graphic text region and a termination portion 106 of the display 100, which in this embodiment, is the bottom of the display. In this embodiment, the graphic text region 104 is a dot matrix region. The icon region 102 is both above and below the graphic text region 104 in this embodiment, forming an upper icon region 108 and a lower icon region 110. The termination portion 106 is the connection point for a display driver 107. In this embodiment, the display driver 107 is configured to be placed on top of the termination portion 106 such as a chip on glass (COG) type IC package. It is understood by those of ordinary skill in the art that other types of termination configurations and IC packages types may be used. Icon segment patterns are formed in each of the icon regions by several icons coupled together by a trace. The icons coupled together form an icon grouping and the icon groupings form the Icon segment pattern.

FIG. 2 illustrates a first layer of the display 100 which has plurality of parallel conductors 202 and a plurality of icons 204. The parallel conductors in this embodiment run horizontally across the display relative to the termination portion 106. The horizontal parallel conductors 202 and the icons 204 are formed on a first substrate 200. The horizontal parallel conductors 202 in this embodiment are a first dot matrix conductive trace set of the dot matrix region 104.

The horizontal parallel conductors 202 and icons 204 may be made of the same conductive material such as etched transparent Indium-Tin-Oxide (ITO) or they may be made of different materials. In this embodiment, the ITO is carried on a glass substrate. It is to be understood that the formation of conductors and traces, for displays in particular, are well known to those of ordinary skill in the art and may be accomplished by various established methods. For example, ITO may be etched into the parallel horizontal conductor configuration 202 and the icon configurations 204 or in another example the ITO may be deposited on the first substrate to form the desired conductors 202 and icons 204.

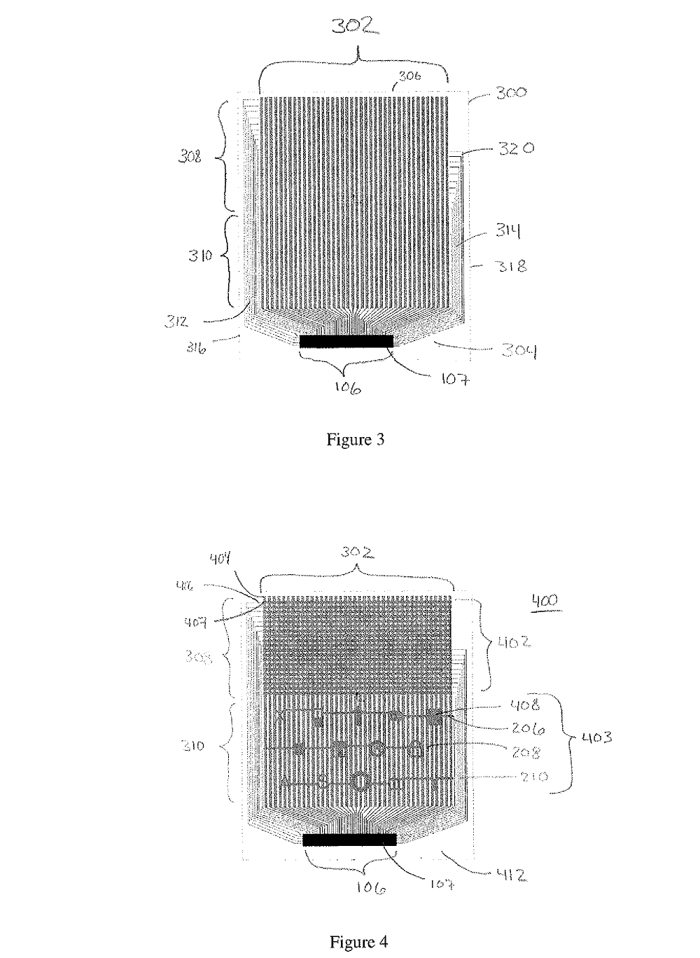

The horizontal conductors 202 run in a horizontal direction such that parallel conductor termination points 208 are configured to exit the dot matrix region 104 on at least one side of the substrate 200. These termination points 208 are termination points connecting to horizontal conductor traces which in turn connect to the display driver 107. The display 100 may be coupled to another circuit board that has a display driver in one embodiment. In another embodiment, the display driver is coupled directly to the display 100. The horizontal conductor termination points 208 exit to the side of the first substrate 200 and connect to horizontal conductor traces 312, 314 on the second substrate 300 (FIG. 3) which run to the bottom of the display 100.

The plurality of icons 204 have conductive traces coupled thereto. In this embodiment there are a plurality of groupings of icons. A first icon grouping 206, a second icon grouping 208 and a third icon grouping 210. Each icon grouping is coupled together by a conductive trace 211, 213 and 215 that has an icon group termination point 216 218, 220. The icon group termination points 216, 218, and 220 are also connected to the display driver 107 similar to the connection of the horizontal conductor termination points 202. Each icon grouping has a plurality of dedicated icon images. Each icon image is made up of one or more icon segments.

FIG. 3 illustrates a second substrate 300 that comprises a plurality of column conductive traces 302. Each column conductive trace runs vertically relative to the termination portion 106 and substantially perpendicular in direction to the horizontal parallel conductors 202. Each column conductive trace terminates at the second substrate bottom 304. In this embodiment, each column conductive trace begins substantially near the top 306 of the second substrate 300. The column conductive traces 302 run parallel to each other in this embodiment. The column conductors 302, as with the horizontal parallel conductors 202, may be made of the same conductive material such as etched transparent Indium-Tin-Oxide (ITO) or they may be made of different materials typically used for displays.

The second substrate 300 and the plurality column conductive traces 302 have an upper region 308 and a lower region 310. Although the upper region 308 and the lower region 310 are defined in FIG. 3 as a specific region, the actual regions are defined by the overlapping portions of the plurality of parallel conductors 202 and a plurality of icons 204 of the first substrate 200 with the column conductive traces 302 of the second substrate with when the two substrates are assembled together. Each conductive trace couples to the horizontal conductors to form a pixel of the dot matrix region and the conductive trace may couple to a segment of a detailed icon image.

FIG. 3 also illustrates the plurality horizontal conductive traces 312, 314 and the column conductive traces 304. The plurality of horizontal conductive traces, 312, 314 are configured on a first side 316 and a second side 318 respectively of the substrate. Each horizontal conductive trace of the plurality of horizontal conductive traces 312, 314 will connect with a horizontal conductor 202 when the first substrate and the second substrate 300 are assembled. For example a first horizontal conductive trace 320 will couple with a first horizontal conductor 222. The first horizontal conductive trace 316 runs down the side of the substrate 300 to the termination portion 106 adjacent to the other traces for both the column traces and the horizontal traces.

The horizontal conductive traces 312, 314 are coupled to the horizontal conductors 202 by a conductive paste in this embodiment. The conductive paste is printed on one of the first substrate or the second substrate or both. In this embodiment, the conductive paste is printed in a bar or rectangular shape. A first rectangular shaped paste bar (not shown) of the conductive paste aligns with the first horizontal conductor 222 and the first horizontal conductive trace 320. In this embodiment, each rectangular conductive paste bar, one for each horizontal conductor) is vertically aligned substantially at the end of each horizontal conductor. In this embodiment, the horizontal conductive traces extend horizontals and then vertically towards the bottom. The horizontal conductive traces at the top of the second substrate extend further away from the horizontal conductor and are configured in a staggered configuration to allow all of the traces to travel to the termination point 106. This configuration of traces is known to those of ordinary skill in the art. Other trace configurations may be used to connect the conductors tot the termination point 106.

FIG. 4 Illustrates the assembled display 400 wherein the first substrate and the second substrates are assembled together and configured one on top of the other forming the dot matrix region 402 and the icon region 403. The upper region 402, which is the dot matrix region 104, is formed by the intersection of the upper region 308 of the column conductive traces and the horizontal conductors 202 of the first substrate 200. For example, a first column conductive trace 404 of the second substrate 300 intersects with a first horizontal conductor 406 to form a single dot matrix element 407 in each row of the dot matrix conductive trace set. The first parallel conductive trace 404 of the second substrate intersects with the icon segment 408 of the icon region 403. The termination portion 405 is located below the icons at the bottom 412 of the display. The assembly of the two substrates is known to those of ordinary skill in the art. The assembled display 400 is shown relative to a display driver 410 which is at the bottom 412 of the display 400.

FIG. 5 illustrates a first and second substrate assembled together having the horizontal conductors 202, the icons 204, and the column conductive traces. Each conductor has a unique address or identifier associated therewith. For example, a first horizontal conductor has the unique identifier “C13” associated therewith. A voltage may be applies across the first horizontal conductor 506 which is identified as “C13.” A first pixel 508 will be energized and light up when voltages are applied across a first column conductive trace 510 that is identified as “S1” and the first horizontal conductor 506. This forms a dot matrix display as is known in the art.

A first icon 512 which is an “S” in this embodiment can be energized and lit up by apply a voltage across column conductive traces (514, 516, 518) which intersect with it in combination with a second horizontal conductor 520.

The resolution of the dot matrix region in this embodiment is not able to display the desired quality icons as with the dedicated icons. The resolution of the icons is defined by the user interface design and the image quality of the icons which is not acceptable if they are displayed in dot matrix form.

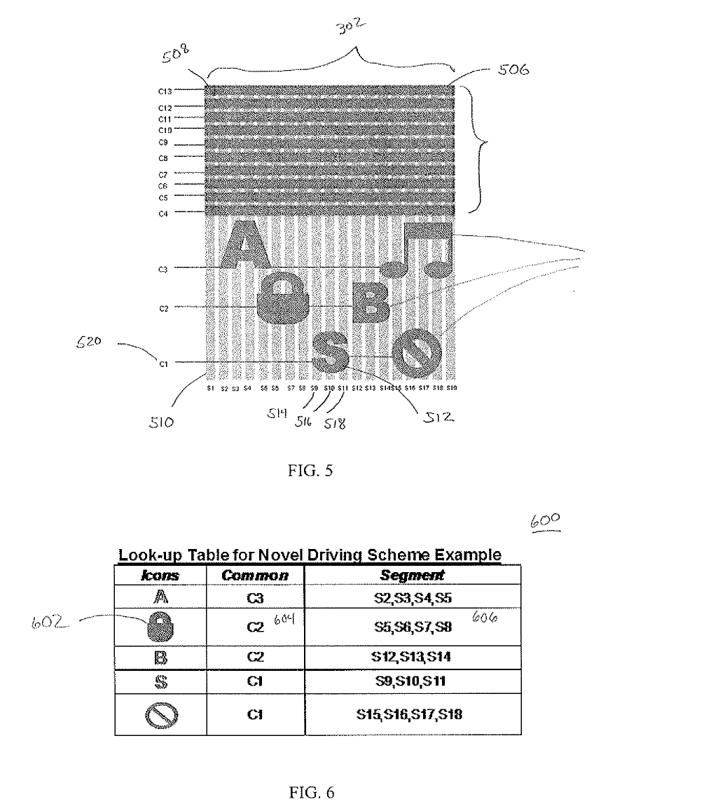

FIG. 6 illustrates a lookup table that shows which horizontal conductors and which column conductive traces are to be energized in order to light which icon or pixel of the dot matrix region. For example, the Lock icon 602 will be lit by energizing the common icon trace “C2” and column conductors “S5,” S6,” “S7,” and “S8.”

A method for controlling the hybrid display having dot matrix area and a dedicated icon region, wherein the dedicated icon region is between a display driver termination area and the dot matrix area, comprises lighting up each icon, of an icon group, individually through driving signals applied to the icon trace in the first substrate and the associated column conductors in the second substrate which intersect the icon in the first substrate.

While the present disclosure and the best modes thereof have been described in a manner establishing possession by the inventors and enabling those of ordinary skill in the art to make and use the same, it will be understood and appreciated that there are many equivalents to the exemplary embodiments disclosed herein and that modifications and variations may be made thereto without departing from the scope and spirit of the inventions, which are to be limited not by the exemplary embodiments but by the appended claims.

What is claimed is:

1. A display comprising:
a display driver termination portion;
a dot matrix area; and
a dedicated icon region having dedicated icon images located in-between the display driver termination area and the dot matrix area, wherein the dot matrix area has a resolution that is greater than the dedicated icon region.

2. The display of claim 1, further comprising a first substrate that carries a first dot matrix conductive trace set of the dot matrix area and a specific icons set of the dedicated icon region.

3. The display of claim 2, further comprising a second substrate that carries a plurality of parallel column conductive traces that intersect with the first dot matrix conductive traces to form the dot matrix area and the icon segments that define the dedicated icon images.

4. The display of claim 3, wherein a first column conductive trace of the second substrate intersects with a single dot matrix element in each row of the horizontal dot matrix conductive trace set in the first substrate to form a single dot matrix element in the dot matrix region, and wherein the first column conductive trace of the second substrate intersects with the icon segment.

5. The display of claim 3, wherein a first column conductive trace of the second substrate intersects with a first row of the horizontal dot matrix conductive trace set in the first substrate to form a single dot matrix element, and wherein a plurality of column conductive traces of the second substrate intersects with a plurality of icon segments of the first substrate to define a first dedicated icon image in the icon region.

6. The display of claim 2, further comprising a single trace coupled between the icon segments and the display driver termination portion.

7. The display of claim 2, further comprising a plurality of traces coupled between the icon segments and the display driver termination portion.

8. A display comprising:
a first substrate including a first portion of a dot matrix display area and an icon region; and
a second substrate, adjacent to the first substrate, that includes a plurality of trace conductors,
wherein single trace conductor of the plurality of trace conductors in the 2^{nd} substrate intersects with a single trace conductor of the dot matrix portion of the first substrate to form a dot matrix element in the dot matrix area, and wherein a plurality of trace conductors of the second substrate intersect with each icon segment pattern in the first substrate to define a icon element in the icon pattern area.

9. The display of claim 8, further comprising a display driver termination area.

10. The display of claim 9, wherein the icon region is configured in-between the display driver termination area and the dot matrix display area.

11. A method for controlling a hybrid display having dot matrix area and a dedicated icon region, wherein the dedicated icon region is between a display driver termination area and the dot matrix area, the method comprising:
controlling each icon, of an icon group, individually through driving signals applied to the icon trace in the first substrate and the associated column conductors in the second substrate which intersect the icon segment pattern in the first substrate.
